(19) United States
(12) Patent Application Publication
(10) Pub. No.: US 2013/0099625 A1
(43) Pub. Date: Apr. 25, 2013

(54) SPINDLE MOTOR

(71) Applicant: SAMSUNG ELECTRO-MECHANICS CO., LTD., Gyunggi-do (KR)

(72) Inventor: Jin San Kim, Gyunggi-do (KR)

(73) Assignee: SAMSUNG ELECTRO-MECHANICS CO., LTD., Gyunggi-do (KR)

(21) Appl. No.: 13/658,234

(22) Filed: Oct. 23, 2012

(30) Foreign Application Priority Data
Oct. 24, 2011 (KR) 10-2011-0108876

(51) Int. Cl. H02K 1/22

(52) U.S. Cl. 310/261.1

(57) ABSTRACT

Disclosed herein is a spindle motor including: a shaft forming a rotation center of the motor; a sleeve receiving the shaft therein and rotatably supporting the shaft; a thrust plate protruding in a direction vertical to an axial direction of the shaft and coupled to an upper end portion of the sleeve in the axial direction; and a stopper including a first plate covering an upper end surface of the thrust plate in the axial direction and a second plate bent from one side end of the first plate in a downward axial direction. According to a preferred embodiment of the present invention, a bent stopper is coupled to one side end of a thrust plate of the spindle motor using a fluid dynamic pressure bearing, thereby making it possible to secure a double or more storage space of oil which is an operating fluid.

### CROSS REFERENCE TO RELATED APPLICATION

This application claims the benefit of Korean Patent Application No. 10-2011-0108876, filed on Oct. 24, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, in order to minimize generation of noise and non-repeatable run out (NRRO) which is vibration generated at the time of use of a ball bearing, a spindle motor including a fluid dynamic pressure bearing having lower driving friction as compared to an existing ball bearing has generally been used. In the fluid dynamic pressure bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic pressure bearing, lubricating oil (hereinafter, referred to as an ‘operating fluid) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in that the shaft is supported by a shaft ball made of iron.

When the fluid dynamic pressure bearing is used in the spindle motor, the rotor is supported by the fluid, such that a noise amount generated in the motor is small, power consumption is low, and impact resistance is excellent.

However, in the spindle motor using the fluid dynamic pressure bearing according to the prior art, various problems such as scattering of the operating fluid according to sealing of the operating fluid in the fluid dynamic pressure bearing have been generated. Particularly, an interface of the operating fluid, that is, an oil interface in the case in which oil is used as the operating fluid is significantly vulnerable to external impact, and the operating fluid is leaked to the outside due to impact, or the like, during operation. In addition, in the spindle motor using the fluid dynamic pressure bearing according to the prior art, a storage space of the operating fluid is insufficient and the oil, or the like, used as the operating fluid easily contacts outside air, such that an evaporation speed of the oil, or the like, is rapid, to cause a phenomenon that the oil is insufficient at the time of use of the spindle motor for a long period of time. The insufficiency of the oil, or the like, used as the operating fluid in the spindle motor using the fluid dynamic pressure bearing causes a problem in a floating fluid of the rotor to have an effect on the entire operation of the hard disk using the spindle motor.

### SUMMARY OF THE INVENTION

The present invention has been made in an effort to provide a spindle motor capable of securing a storage space of an operating fluid forming a fluid dynamic pressure bearing and improving a sealing effect of the operating fluid by inserting a bent stopper on a thrust plate.

According to a preferred embodiment of the present invention, there is provided a spindle motor including: a shaft forming a rotation center of the motor; a sleeve receiving the shaft therein and rotatably supporting the shaft; a thrust plate protruding in a direction vertical to an axial direction of the she and coupled to an upper end portion of the sleeve in the axial direction; and a stopper including a first plate covering an upper end surface of the thrust plate in the axial direction and a second plate bent from one side end of the first plate in a downward axial direction.

The spindle motor may further include a hub having the shaft coupled integrally therewith at a center portion thereof, coupled to an upper portion of the shaft in the axial direction so as to correspond to one end surface of the sleeve, and having a protrusion part formed in the downward axial direction, wherein oil is filled in a spaced space formed between an outer side surface of the first plate and an inner side surface of the hub facing to the outer side surface of the first plate and a spaced space formed between an outer side surface of the second plate and an inner side surface of the protrusion part of the hub facing the outer side surface of the second plate, and an oil sealing part is formed in the axial direction in the spaced space formed between the outer side surface of the second plate and the inner side surface of the protrusion part of the hub facing the outer side surface of the second plate.

The first and second plates may be bent from each other by 90 degrees.

The first plate may include a first groove formed in the outer side surface thereof.

The hub may include a second groove formed in the inner side surface thereof and corresponding to the first groove.

Oil may be filled in a spaced space between one side end of the thrust plate in the protrusion direction and an inner side surface of the second plate facing one side end of the thrust plate.

The stopper may have a ring shape.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a spindle motor according to a preferred embodiment of the present invention;

FIG. 2 is an enlarged cross-sectional view of a stopper according to a first preferred embodiment of the present invention; and

FIG. 3 is an enlarged cross-sectional view of a stopper according to a second embodiment of the present invention.

### DESCRIPTION OF THE PREFERRED EMBODIMENTS

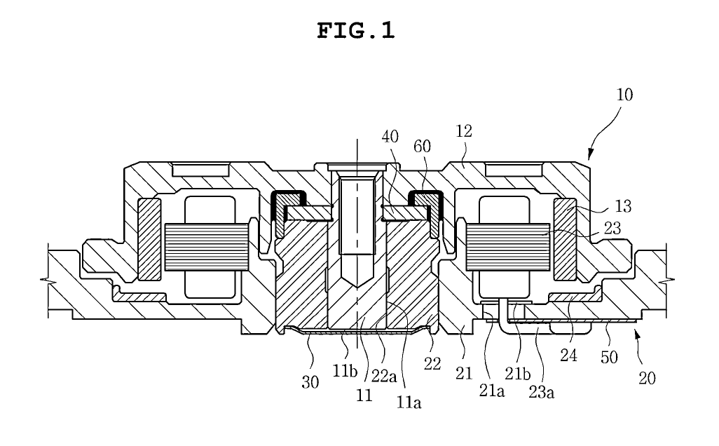

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In addition, a term “an axial direction” in the present invention refers to a direction in which a shaft of a spindle motor is formed, more specifically, a direction in which a shaft of a spindle motor shown in FIG. 1, and “upward and downward directions” refer to upward and downward directions extended in the axial direction. In describing the present invention, a detailed description of related known functions or configurations will be omitted so as not to obscure the gist of the present invention

Hereinafter, preferred embodiments of the present invention will be described in detail with reference to the attached drawings.

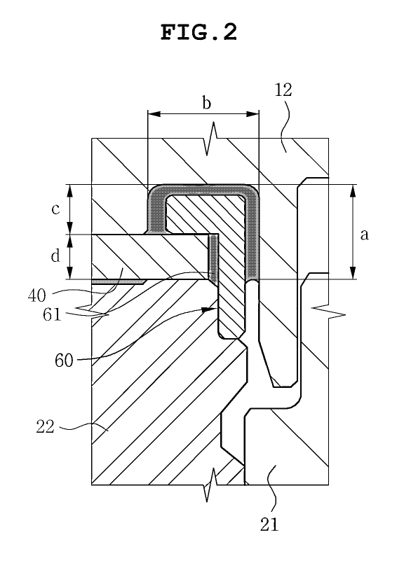

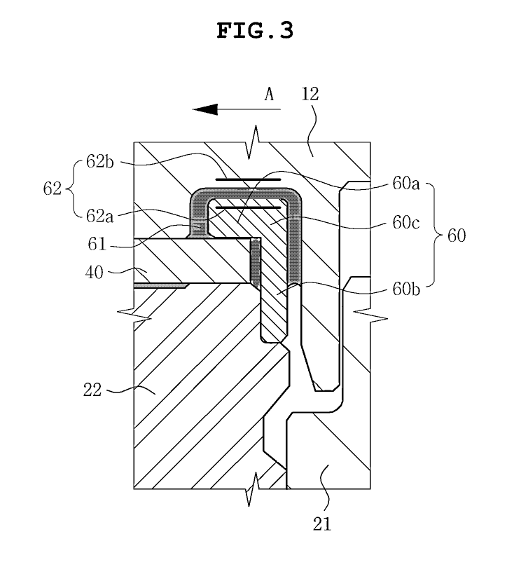

FIG. 1 is a cross-sectional view of a spindle motor according to a preferred embodiment of the present invention; FIG. 2 is an enlarged cross-sectional view of a stopper according to a first preferred embodiment of the present invention; and FIG. 3 is an enlarged cross-sectional view of a stopper according to a second embodiment of the present invention.

The spindle motor according to the preferred embodiment of the present invention is configured to include a shaft 11 forming a rotation center of the motor, a sleeve 22 receiving the shaft 11 therein and rotatably supporting the shaft 11, a thrust plate 40 protruding in a direction vertical to an axial direction of the shaft 11 and coupled to an upper end portion of the sleeve 22 in the axial direction, and a stopper 60 including a first plate 60a covering an upper end surface of the thrust plate 40 in the axial direction and a second plate 60c bent from one side end of the first plate 60a in a downward axial direction.

The shaft 11 forms a center axis around which the spindle motor rotates and has generally a cylindrical shape. The thrust plate 40 for forming a thrust dynamic pressure bearing part by a fluid dynamic pressure bearing may be insertedly installed so as to be orthogonal to an upper side portion of the shaft 11. Here, the thrust plate 40 may be formed at the upper side portion of the shaft 11 or be insertedly installed so as to be orthogonal to a lower end portion of the shaft 11. In order to fix the thrust plate 40 to the shaft 11, separate laser welding, or the like, may be performed. However, it is obvious to those skilled in the art that the thrust plate 40 may be press-fitted into the shaft 11 by being applied with a predetermined pressure. A dynamic pressure generation groove (not shown) may be formed in any one of the facing surfaces of the thrust plate 40 and the sleeve 22 in order to form the thrust dynamic pressure bearing part by the fluid dynamic pressure bearing.

The sleeve 22 may receive the shaft 11 therein and have a hollow cylindrical shape so as to rotatably support the shaft 11, and a radial dynamic pressure bearing part by oil 61, which is an operating fluid, may be formed in an outer peripheral surface 11a of the shaft 11 and an inner peripheral surface 22a of the sleeve 22 coupled to each other. In addition, a dynamic pressure generation groove (not shown) for generating dynamic pressure of the radial dynamic pressure bearing part may be formed in any one of the outer peripheral surface 11a of the shaft 11 and the inner peripheral surface 22a of the sleeve 22 in which the radial dynamic pressure bearing part is formed.

The thrust plate 40 protrudes in the direction vertical to the axial direction of the shaft 11 and is coupled to an upper end portion of the sleeve 22 in the axial direction. The thrust plate 40 may have the oil 61, which is the operating fluid, filled in a surface thereof corresponding to an upper end surface of the sleeve 22 in the axial direction to form the thrust dynamic pressure bearing part. In the case in which an amount of oil 61 used as the operating fluid in the fluid dynamic pressure bearing is insufficient or the oil 61 is leaked to the outside, a problem has been generated in an operation of the spindle motor. Therefore, a filling amount of oil 61 which is the operating fluid forming the fluid dynamic pressure bearing and maintenance of an oil sealing part are very important elements. Therefore, according to the preferred embodiment of the present invention, a separate bent stopper 60 is formed to enclose one side end of the thrust plate 40, thereby making it possible to prevent evaporation, or the like, of the oil 61 filled in the radial dynamic pressure bearing part formed between the outer peripheral surface 11a of the shaft 11 and the inner peripheral surface 22a of the sleeve 22 as well as the thrust dynamic pressure bearing part and prevent scattering, or the like, of the oil 61 due to external impact or vibration generated during an operation of the spindle motor.

A hub 12, which is to mount and rotate an optical disk (not shown) or a magnetic disk (not shown) thereon, has the shaft 11 coupled integrally therewith at the center thereof and is coupled to an upper portion of the shaft 11 so as to correspond to the upper end surface of the sleeve 22 in the axial direction. In addition, the hub 12 includes a protrusion part 12a extended in the downward axial direction. The oil 61 is filled in a spaced space between the protrusion part 12a and a second plate 60c of a stopper 60 to be described below facing the protrusion part 12a to form the oil sealing part.

The stopper 60 includes the first plate 60a covering the upper end surface of the thrust plate 40 in the axial direction and the second plate 60c bent from one side end of the first plate 60a in the downward axial direction to enclose the thrust plate 40. The second plate 60c is formed so as to be bent from a bent part 60b at one side end of the first plate 60a in the downward axial direction by a predetermined angle. As shown in FIG. 1, the stopper 60 may be formed to have a ‘┐’ shape. However, the stopper 60 may be formed to have various shapes according to a bent angle of the bent part 60b. The first and second plates 60a and 60c forming the stopper 60 are bent from each other, such that the oil 62, which is the operating fluid, is filled in a spaced space (See b of FIG. 2) between an outer side surface of the first plate 60a and an inner side surface of the hub 12 facing to the outer side surface of the first plate 60a and a spaced space (See a of FIG. 2) between an outer side surface of the second plate 60c and an inner side surface of the protrusion part 12a of the hub 12 facing the outer side surface of the second plate 60c. Particularly, the oil sealing part in which an oil interface is formed may be formed in the spaced space between the outer side surface of the second plate 60c and the inner side surface of the protrusion part 12a of the hub 12 facing the outer side surface of the second plate 60c. The first and second plates 60a and 60c of the stopper 60 are bent from each other, such that a space in which the oil 61 is filled may be secured. More specifically, as in the first preferred embodiment of the present invention shown in FIG. 2, filling spaces of the oil 61 are formed in a spaced space c formed between an inner side surface of the second plate 60c and an outer side end of the thrust plate 40 and a section d facing the hub 12 in an inward direction of the first plate 60a as well as the sections a and b formed by the first and second plates 60a and 60c of the to stopper 60 described above, thereby making it possible to secure the storage space of the oil 61 and decrease a surface of the oil 61 exposed to the outside. Therefore, it is possible to prevent a decrease in an oil amount due to the evaporation, or the like, of the oil 61. The stopper 60 may have a ring shape. However, it is obvious to those skilled in the art that a shape of the stopper may be changed by appropriately changing a design according to a shape and a feature of the spindle motor.

FIG. 3 is an enlarged cross-sectional view of a stopper 60 according to a second embodiment of the present invention. As shown in FIG. 3, the stopper 60 may further include a pumping groove 62 formed in order to pump the oil 61, which is the operating fluid, inwardly from the oil sealing part during the operation of the spindle motor. The pump groove 62 includes a first pumping groove 62a and a second pumping groove 62b.

The first groove 62a is formed in the outer side surface of the first plate 60a, and the second groove 62b is formed in the inner side surface of the hub 12, corresponding to the first groove 62a. The pumping groove 62 pumps the oil 61, which is the operating fluid, in an A direction at the time of rotation of the motor, thereby making it possible to prevent destruction of the oil interface and leakage of the oil 61 which is the operating fluid. Both of the first and second grooves 62a and 62b of the pumping groove 62 may be formed. However, any one of the first and second grooves 62a and 62b, that is, the first groove 62a or the second groove 62b may be selectively applied and formed.

The pumping groove 62 may be formed to have a pattern of a herringbone groove having a central bent part or be formed to have a continuously formed spiral groove. In addition, a shape of the pumping groove 62 may be variously changed according to a rotation direction and a rotation feature of the spindle motor.

The base 21 has one side surface coupled to an outer peripheral surface of the sleeve 22 so to that the sleeve 22 including the shaft 11 is coupled to an inner side thereof. The base 21 has a core 23 coupled to the other side surface thereof, which is an opposite side to one side surface thereof, at a position corresponding to that of a rotor magnet 13 formed on the hub 12, wherein the core 23 has a winding coil 23a wound therearound. The base 21 may serve to support the entire structure of the spindle motor at a lower portion of the spindle motor and be manufactured by a press processing method or a die-casting method. In the case in which the base 21 is manufactured by the press processing method, the base 21 may be made of various metal materials such as aluminum, steel, and the like, particularly, a material having rigidity. The base 21 and the sleeve 22 may be assembled to each other by applying an adhesive to an inner surface of the base 21 or an outer surface of the sleeve 22. A conductive adhesive (not shown) for conduction between the base 21 and the sleeve 22 may be connected to and formed on a lower end surface of a portion at which the base 21 and the sleeve 22 are bonded to each other. The conductive adhesive is formed to allow excessive charges generated at the time of the operation of the motor to flow out through the base 21, thereby making it possible to improve reliability of the operation of the motor.

The core 23 is generally formed by stacking a plurality of thin metal plates and is fixedly disposed on the base 21 including a flexible printed circuit board 50. A plurality of through-holes 21a may be formed so as to correspond to the coil 23a led from the winding coil 23a, and the coil 23a led through the through-holes 21a may be soldered and electrically connected to the flexible printed circuit board 50. In order to insulate between the coil 23a led through the through-hole 21a and the base 21, an insulating sheet 12b may be further formed at an inlet portion of the through-hole 21a.

A cover member 30 is coupled to the sleeve 22 in order to cover lower end surfaces of the shaft 11 and the sleeve 22 in the axial direction. The cover member 30 has a structure in which it is coupled to the sleeve 22 while entirely covering a lower end of the sleeve 22, such that it may store the oil 61, which is the operating fluid, formed in the fluid dynamic pressure bearing.

Components of the spindle motor according to the preferred embodiment of the present invention and an operation relationship therebetween will be briefly described below with reference to FIG. 1.

A rotor 10 may include the shaft 11 becoming a rotation axis and rotatably formed and the hub 12 having the rotor magnet 13 attached thereto, and a stator 20 may include the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N and S poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 may be made of a metal material so that attractive force acts between the pulling plate 23 and the rotor magnet 13. More specifically, the pulling plate 24 may be made of a material such as an SUS material, nickel, gold, or the like. In addition, a material of the pulling plate 24 is not limited to the above-mentioned material as long as it is a metal material having a property allowing attractive force to acts between the pulling plate 23 and the rotor magnet 13. The pulling plate 24 and the rotor magnet 13 have attractive force acting therebetween, thereby making it possible to stably rotate the motor.

As set forth, according to the preferred embodiment of the present invention, the bent stopper is coupled to one side end of the thrust plate of the spindle motor using the fluid dynamic pressure bearing, thereby making it possible to secure double or more storage space of the oil which is the operating fluid.

In addition, the bent stopper is coupled to one side end of the thrust plate of the spindle motor using the fluid dynamic pressure bearing, thereby making it possible to reduce evaporation of the oil which is the operating fluid due to the exposure of the oil to outside air.

Further, the bent stopper is coupled to one side end of the thrust plate of the spindle motor using the fluid dynamic pressure bearing to improve a sealing effect of the oil which is the operating fluid, thereby making it possible to prevent the oil from being scattered or leaked to the outside due to the external impact or the vibration at the time of driving of the motor.

Furthermore, the bent stopper is coupled to one side end of the thrust plate of the spindle motor using the fluid dynamic pressure bearing and the pumping groove is formed in the surface of the stopper or the hub corresponding to the stopper to move the oil which is the operating fluid inwardly, thereby making it possible to prevent the scattering or the leakage of the oil in advance.

Moreover, the stopper coupled to one side end of the thrust plate of the spindle motor using the fluid dynamic pressure bearing is bent at an angle of 90 degrees and the oil which is the operating fluid is filled between the thrust plate facing the inner side surface of the stopper and the inner side surface of the protrusion part of the hub, thereby making it possible to increase the oil storage space and decrease the evaporation of the oil due to the exposure of the oil to the outside.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft forming a rotation center of the motor;
a sleeve receiving the shaft therein and rotatably supporting the shaft;
a thrust plate protruding in a direction vertical to an axial direction of the shaft and coupled to an upper end portion of the sleeve in the axial direction; and
a stopper including a first plate covering an upper end surface of the thrust plate in the axial direction and a second plate bent from one side end of the first plate in a downward axial direction.

2. The spindle motor as set forth in claim 1, further comprising a hub having the shaft coupled integrally therewith at a center portion thereof, coupled to an upper portion of the shaft in the axial direction so as to correspond to one end surface of the sleeve, and having a protrusion part formed in the downward axial direction,
wherein oil is filled in a spaced space formed between an outer side surface of the first plate and an inner side surface of the hub facing to the outer side surface of the first plate and a spaced space formed between an outer side surface of the second plate and an inner side surface of the protrusion part of the hub facing the outer side surface of the second plate, and an oil sealing part is formed in the axial direction in the spaced space formed between the outer side surface of the second plate and the inner side surface of the protrusion part of the hub facing the outer side surface of the second plate.

3. The spindle motor as set forth in claim 1, wherein the first and second plates are bent from each other by 90 degrees.

4. The spindle motor as set forth in claim 2, wherein the first plate includes a first groove formed in the outer side surface thereof.

5. The spindle motor as set forth in claim 4, wherein the hub includes a second groove formed in the inner side surface thereof and corresponding to the first groove.

6. The spindle motor as set forth in claim 1, wherein oil is filled in a spaced space between one side end of the thrust plate in the protrusion direction and an inner side surface of the second plate facing one side end of the thrust plate.

7. The spindle motor as set forth in claim 1, wherein the stopper has a ring shape.
